(19) United States
(12) Patent Application Publication
(10) Pub. No.: US 2010/0125396 A1
(43) Pub. Date: May 20, 2010

(54) HYDRAULIC CONTROL APPARATUS FOR SPEED RATIO CHANGE

(75) Inventors: Shih-Hsin Hsu, Taipei County (TW); Yi-Hsuan Hung, Taipei City (TW); Tseng-Te Wei, Hsinchu City (TW); Chun-Hsien Lu, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/422,097

(22) Filed: Apr. 10, 2009

(30) Foreign Application Priority Data
Nov. 18, 2008 (TW) 097144502

(51) Int. Cl. G06F 19/00; F16H 61/662

(52) U.S. Cl. 701/55

(57) ABSTRACT

The present invention provides a hydraulic control apparatus for controlling the speed ratio change of a transmission system. The apparatus, disposed on a carrier, comprises a first pulley unit, a second pulley unit, a first hydraulic drive circuit, a second hydraulic drive circuit, and a hydraulic control circuit and a controller. The first pulley unit coupled to the second pulley unit by a transmission belt, and the first pulley unit and the second pulley unit are fluidly connected to the first and the second hydraulic drive circuit respectively. The hydraulic control circuit fluidly connected to the independent first and second hydraulic drive circuit. The controller functions to switch the series or parallel connection status between the first and second hydraulic drive circuit according to the moving status of the carrier through the hydraulic control circuit so that the speed ratio change is capable of being adjusted continuously and synchronously.

### FIELD OF THE INVENTION

The present invention relates to a hydraulic control apparatus for speed ratio change, and more particularly, to a hydraulic transmission apparatus capable of changing a reduction ratio according to the moving status of a carrier.

### BACKGROUND OF THE INVENTION

Please refer to FIG. 1, which shows a conventional hydraulic continuous variable transmission system. In FIG. 1, the variable transmission system 1 comprises an engine input shaft 10 and a torque converter 101. The torque converter 101 is connected to an input pulley 12 through a clutch 11 while the input pulley 12 is further connected to an output pulley 14 by a metal belt 13. Moreover, the output pulley 14 is further connected with a reduction gear set 15 as the reduction gear set 15 is connected to a differential gear 16. As each of the two pulleys 12, 14 are made of two cones facing each other and the belt 13 is riding in the groove between the two cones, the belt will ride lower in the groove when the two cones of the pulley are far apart for enabling the radius of the belt loop going around the pulley to get smaller and on the contrary, the belt will ride higher in the groove when the cones are close together for enabling the radius of the belt loop going around the pulley to get larger. Thus, when an hydraulic pump is brought along to function by an engine for generating a hydraulic pressure to be used for causing the the two pulleys 12, 14 to perform an axial movement, the distances D between the two cones of the pulleys 12, 14 will be varied accordingly so that the pitch radius of the belt 13 will be caused to change and thus determines a reduction gear ratio.

There can be two primary types of transmission efficiency loss happening in the conventional hydraulic continuous variable transmission system, which are pressure loss and outflow rate loss. Notably, there is only one hydraulic pump used in the conventional hydraulic continuous variable transmission system of FIG. 1 that is brought along to function by the engine in a manner that the hydraulic pressure and flow caused by the hydraulic pump will increase with the increasing of the engine rotation speed. However, such configuration will cause the conventional hydraulic continuous variable transmission system to suffer a high efficiency loss, since the hydraulic pump will keep working and thus exhausting energy even when the engine is idle. Moreover, since the energy conversion efficiency of the engine can reach no higher then 30%, the operation of hydraulic pump driven by the engine will certainly cause great energy loss.

Please refer to FIG. 2, which shows a conventional hydraulic continuous variable transmission system disclosed in U.S. Pat. No. 7,261,672. In FIG. 2, there are two motor-driven hydraulic pumps 20, 21 being configured in this transmission system, that are used as a primary pump 20 and an secondary pump 21 for outputting pressure to control the first and the second pulleys 22, 23 to perform an axial movement. Thereby, the distances D between the two cones of the pulleys 22, 23 will be varied accordingly so that the pitch radius of its transmission belt will be caused to change and thus determines a reduction gear ratio. However, it is noted that the primary hydraulic loop of the aforesaid variable transmission system is formed by serial-connecting its secondary hydraulic circuits, so that when the two pumps 20, 21 are control for changing the reduction gear ratio, turbulence will be caused due to the interference between the hydraulic circuits. There is another control device disclosed in U.S. Pat. No. 6,287,227 that is designed to use a linkage mechanism as hydraulic pressure control so as to determine a reduction gear ratio for a continuous variable transmission (CVT) system. In addition, another gear ratio control device is disclosed in U.S. Pub. No. 2008/0146409, in which the hydraulic pressure is controlled and determined by a step motor which controls the open degree of a hydraulic valve, and thereby controls the reduction gear ratio to be adjusted continuously.

### SUMMARY OF THE INVENTION

The present invention provides a hydraulic control apparatus for speed ratio change capable of using two independent hydraulic drive circuits along with two hydraulic control circuits connected respectively thereto for achieve a speed ratio change in a continuous manner while maintaining a power source of the hydraulic control apparatus, such as a motor or an engine, to function within its optimum efficiency region for achieving low energy consumption and low pollution during the operation of the power source.

The present invention further provides a hydraulic control apparatus for speed ratio change, being a continuous variable transmission device of two independent hydraulic drive circuits and two hydraulic control circuits connected respectively thereto, that is able to enable the two hydraulic drive circuits to be parallel-connected for satisfying a comparatively large torque demand while maintaining a stable output with regard to torque and speed, by that not only the comfort and safety of carrier where the hydraulic control apparatus is mounted can be ensured as it is cruising in low speed, but also no vibration will be caused by any speed changing of the carrier.

The present invention further provides a hydraulic control apparatus for speed ratio change, being a continuous variable transmission device of two independent hydraulic drive circuits and two hydraulic control circuits connected respectively thereto, that is able to enable the two hydraulic drive circuits to be serial-connected for satisfying a high-speed cruising demand of a carrier as the serial connection will cause a smaller reduction ratio for enabling the carrier to cruise stably in high speed.

In an embodiment, the present invention provides a hydraulic control apparatus for speed ratio change, comprising: a first pulley unit, connected to a power source so as to be driven thereby; a second pulley unit, coupled to the first pulley unit by a transmission belt while being connected to a power output mechanism; a first hydraulic drive circuit, connected to the first pulley unit; a second hydraulic drive circuit, connected to the second pulley unit; a hydraulic control circuit, fluidly connected to the first and the second hydraulic drive circuits in respective; and a controller, electrically connected to the first hydraulic drive circuit, the second hydraulic drive circuit and the hydraulic control circuit; wherein, the controller is enabled to issue a control signal for controlling the hydraulic control circuit to perform a task selected from the group consisting of: enabling the first hydraulic drive circuit and the second hydraulic drive circuit to serial-connected, and enabling the first hydraulic drive circuit and the second hydraulic drive circuit to be parallel-connected.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a sectional view of a conventional hydraulic continuous variable transmission system.

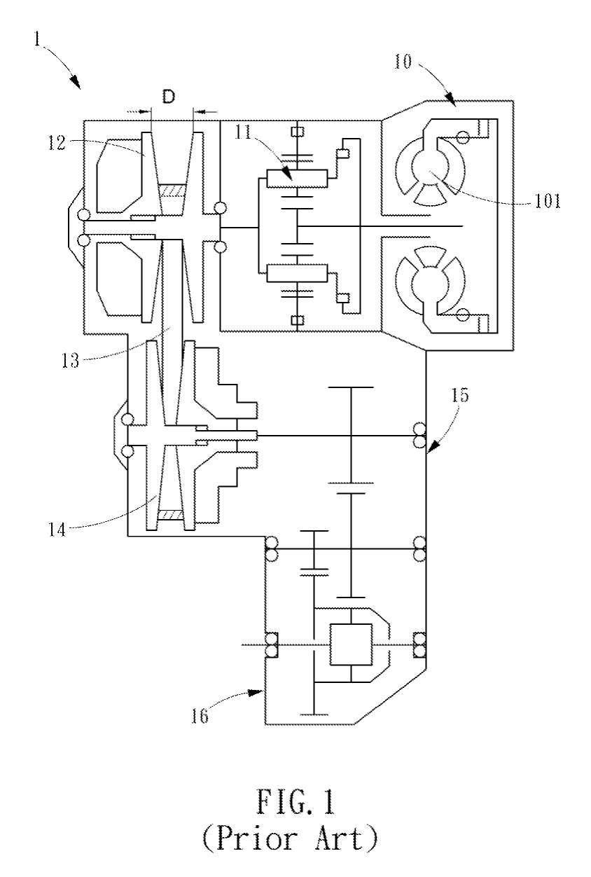

FIG. 2 shows a conventional hydraulic continuous variable transmission system disclosed in U.S. Pat. No. 7,261,672.

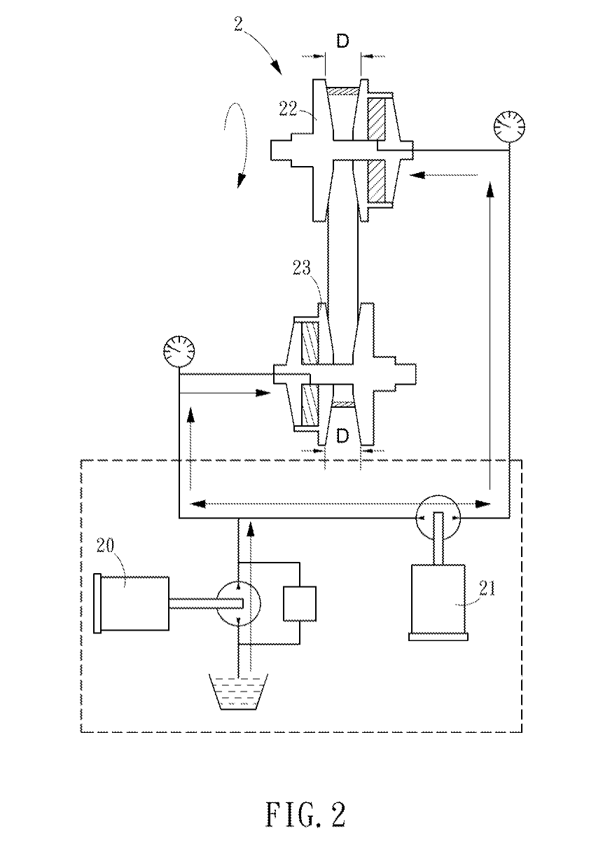

FIG. 3 is a schematic diagram showing a hydraulic control apparatus for speed ratio change according to an embodiment of the invention.

FIG. 4 shows a hydraulic control apparatus of the invention as the hydraulic drive circuits configured therein are parallel-connected.

FIG. 5A and FIG. 5B are schematic diagrams illustrating how the pitch radius of the transmission belt is changed by the use of pulley units of the invention.

FIG. 6 shows a hydraulic control apparatus of the invention as the hydraulic drive circuits configured therein are serial-connected.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

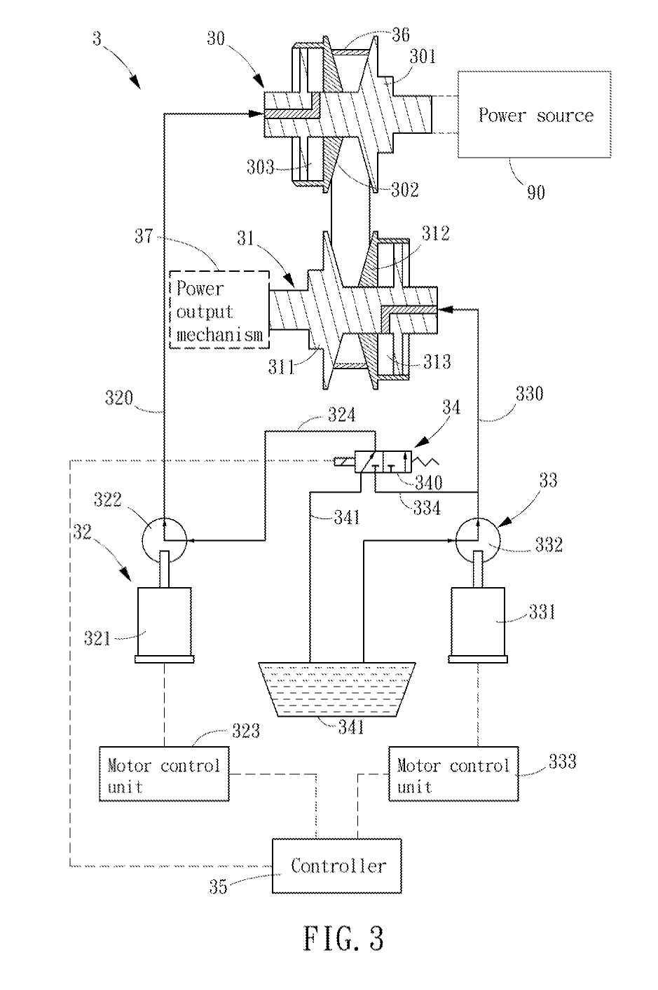

Please refer to FIG. 3, which is a schematic diagram showing a hydraulic control apparatus for speed ratio change according to an embodiment of the invention. In this embodiment, the hydraulic control apparatus is adapted for mounting on a carrier to be used as a hydraulic continuous variable transmission device, and the carrier can be a vehicle or other transportation devices. The hydraulic control apparatus 3 of FIG. 3 comprises: a first pulley unit 30, a second pulley unit 31, a first hydraulic drive circuit 32, a second hydraulic drive circuit 33, a hydraulic control circuit 34 and a controller 35. The first pulley unit 30 is composed of a first fixed pulley 301 and a first movable pulley 302, in which a fluid chamber 303 is formed sandwiching between the first fixed pulley 301 and the first movable pulley 302 and is used for holding a fluid, such as oil, therein and consequently causing a pressure to be exerted on the first movable pulley 302 so as to force the same to perform an axial movement.

The first pulley unit 30 is further connected to a power source 90 so as to be driven thereby. Generally, the power source can be an engine, a motor or a hybrid power source, and so on, but is not limited thereby. The second pulley unit 31 is disposed at a side of the first pulley unit 30 while being connected to the same by a transmission belt 36 so that power of the power source 90 can be transmitted from the first pulley unit 30 to the second pulley unit 31 where it is further being transmitted to a power output mechanism 37. In this embodiment, the transmission belt 36 is a metal belt, but is not limited thereby. Similarly, the second pulley unit 31 is composed of a second fixed pulley 311 and a second movable pulley 312, in which a fluid chamber 313 is formed sandwiching between the second fixed pulley 311 and the second movable pulley 312 and is used for holding a fluid, such as oil, therein and consequently causing a pressure to be exerted on the second movable pulley 312 so as to force the same to perform an axial movement.

The first hydraulic drive circuit 32 is designed to use a pipeline 320 to connect fluidly with the fluid chamber 303 by way of the first fixed pulley 301. In this embodiment, the first hydraulic drive circuit 32 is comprised of a servo motor 321 and a hydraulic pump 322, in which the servo motor 321 is connected to the controller 35 by a motor control unit 323; and the hydraulic pump 322 is connected to the servo motor 321 for receiving power from the same and thus outputting a controllable hydraulic pressure for pressing the fluid to flow through the pipeline 320 and then into the fluid chamber 303 of the first pulley unit 30. It is noted that the hydraulic pump 322 is further connected to the hydraulic control circuit 34 by a pipeline 324. Similarly, the second hydraulic drive circuit 33 is designed to use a pipeline 330 to connect fluidly with the fluid chamber 313 by way of the second fixed pulley 311. Also in this embodiment, the second hydraulic drive circuit 33 is comprised of a servo motor 331 and a hydraulic pump 332, in which the servo motor 331 is connected to the controller 35 by a motor control unit 333; and the hydraulic pump 332 is connected to the servo motor 331 for receiving power from the same and thus outputting a controllable hydraulic pressure for pressing the fluid to flow through the pipeline 330 and then into the fluid chamber 313 through the second fixed pulley unit 311. Moreover, the hydraulic pump 332 is further connected to the hydraulic control circuit 34 by a pipeline 334.

The hydraulic control circuit 34 is respectively connected to the first hydraulic drive circuit 32 and the second hydraulic drive circuit 33. Moreover, the hydraulic control circuit 34 is configured with a control valve 340 which is connected to the first hydraulic drive circuit 32, the second hydraulic drive circuit 33 and a fluid tank 341 respectively by way of the pipelines 324, 334, 341. As shown in FIG. 3, there is a fluid contained in the fluid tank 341 that can be fed to the aforesaid hydraulic drive circuits for enabling the same to function. In addition, the fluid in the fluid tank can be a kind of oil. In this embodiment, the control valve 340 is configured for switching the series or parallel connection status between the first hydraulic drive circuit 32 and the second hydraulic drive circuit 33. In this embodiment, the control valve 340 can be a solenoid electric valve, such as a 3-way, 2-position solenoid electric valve, but is not limited thereby. The controller 35 is electrically connected to the first hydraulic drive circuit 32, the second hydraulic drive circuit 33 and the hydraulic control circuit 34 in a manner that the controller 35 is enabled to issue a control signal for controlling the hydraulic control circuit 34 to perform a task selected from the group consisting of: enabling the first hydraulic drive circuit 32 and the second hydraulic drive circuit 33 to serial-connected with each other, and enabling the first hydraulic drive circuit 32 and the second hydraulic drive circuit 33 to be parallel-connected with each other.

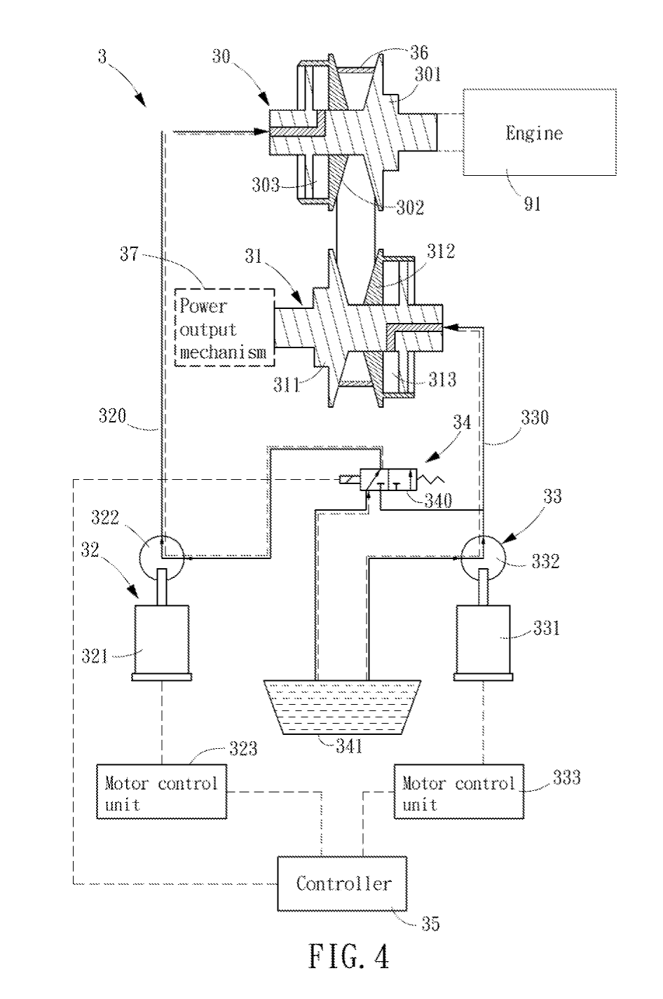

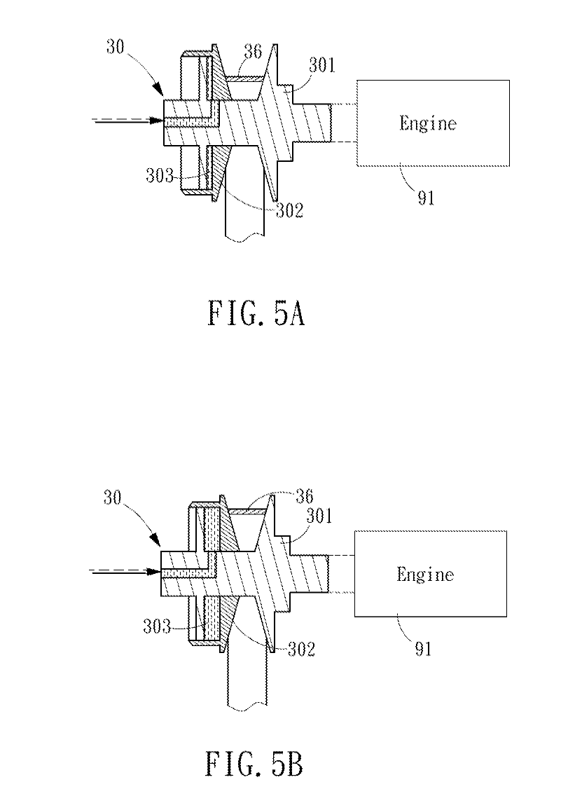

The hydraulic control apparatus for speed ratio change 3 of the invention can be adapted for all kinds of vehicles of different power source, such as engine-driven vehicles, hybrid-power vehicles or electric power vehicle, and so on. The following embodiments are provides for illustrating how the hydraulic control apparatus of the invention is used for achieving continuous variable transmission as it is being mounted on a vehicle. Please refer to FIG. 4, which shows a hydraulic control apparatus of the invention as the hydraulic drive circuits configured therein are parallel-connected. In FIG. 4, the hydraulic control apparatus 3 is coupled to an engine 91 and a kind of oil is used as the fluid in the fluid circuit of the hydraulic control apparatus 3. It is noted that when the engine 91 is just being started and is operating within its worst operation efficiency region, it is the time when the vehicle is driven to move from a standing stop and thus it is the time requiring the engine to output a large torque with low rotation speed. Therefore, a transmission with high reduction ratio is required, since it can rapidly switch the engine from operating in a low-speed low-efficiency status to a high-speed high-efficiency status. For obtaining a transmission with high reduction ratio, the pitch radius of the first pulley unit 30, known as the distance between the center of the first pulley unit 30 to where the metal belt 36 makes contact in the groove, should be smaller than that of the second pulley unit 31. In another word, the oil pressure exerting on the first pulley unit 30 should be smaller than that on the second pulley unit 31. Please refer to FIG. 5A and FIG. 5B, which are schematic diagrams illustrating how the pitch radius of the transmission belt is changed by the use of pulley units of the invention. Taking the first pulley unit 30 for instance, it is known that the pitch radius of the first pulley unit 30 can be increased by enabling the pump to pressurize the fluid for forcing the same to flow into the fluid chamber 303. Since the hydraulic pressure in the fluid chamber 303 will force the first movable pulley 302 to move foreward as depicted in FIG. 5A, the distance between the first fixed pulley 301 and the first movable pulley 302 will be changed in consequency while enabling the metal belt 36 to move upward accordingly and thus the distance between the center of the first pulley unit 30 to where the metal belt 36 makes contact in the groove is increased, as shown in FIG. 5B. Moreover, the aforesaid description is also true for the second pulley unit 31.

In FIG. 4, the controller 35 issues control commands to the motor control units 323, 333 for controlling the rotation speeds of the two servo motors 321, 331 accordingly, through which controls the output pressures of the hydraulic pumps 322, 333 as they are connected respectively to the first and the second pulley units 30, 31. When the control valve 340 is maintained at its normal position for enabling a parallel connection in its hydraulic circuits, the hydraulic pump 332 connecting to the second pulley unit 31 and the hydraulic pump 322 connecting to the first pulley unit 30 will be able to establish their hydraulic pressures independent from each other which are then being used for forcing the fluid to flow into the fluid chambers 303, 313 in corresponding to their respective hydraulic pressures and thus causing the first and the second movable pulleys 302, 312 to perform their corresponding axial movements. In addition, as the controller 35 will direct the servo motor 321 to rotate slower than the servo motor 331, the hydraulic pressure of the hydraulic pump 322 connecting to the first pulley unit 30 will be smaller than that of the hydraulic pump 31 connecting to the second pulley unit 31 which will enable the hydraulic control apparatus to achieve its maximum reduction ratio.

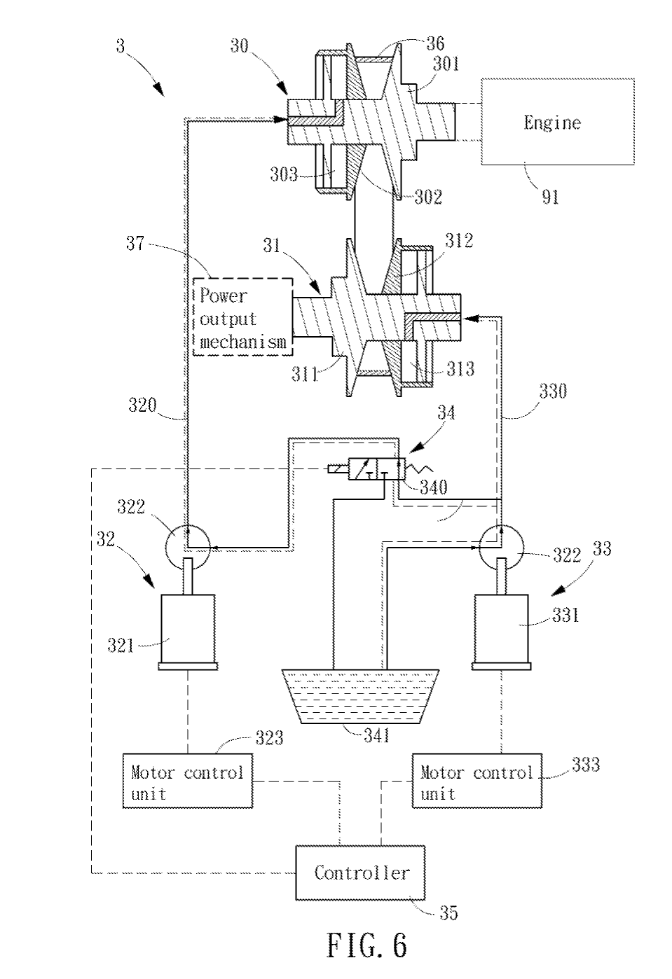

Please refer to FIG. 6, which shows a hydraulic control apparatus of the invention as the hydraulic drive circuits configured therein are serial-connected. When the vehicle is moving in high speed, it is the time requiring the engine to output a small torque with high rotation speed. Thus, for maintaining the engine to operate stably in high efficiency region as it is rotating in high speed, a transmission with low reduction ratio is required. For achieving a transmission with low reduction ratio, the pitch radius of the first pulley unit 30 should be equal to or slightly smaller than that of the second pulley unit 31. In another word, the oil pressure exerting on the first pulley unit 30 should be larger than that on the second pulley unit 31. Similarly, the controller 35 will issues control commands to the motor control units 323, 333 for controlling the rotation speeds of the two servo motors 321, 331 accordingly, through which controls the output pressures of the hydraulic pumps 322, 333 as they are connected respectively to the first and the second pulley units 30, 31. However, at this time, the control valve 340 of the hydraulic control circuit 34 will be activated to switch its hydraulic circuits from parallel connection into series connection. In this series connection, the hydraulic pressure of the hydraulic pump 332 connecting to the second pulley unit 31 is diverted to the two pipelines 320, 330, in which the pipeline 330 is fluidly connected to the fluid chamber 313 sandwiched between the second fixed pulley 311 and the second movable pulley 310 for forcing the second movable pulley 310 to perform an axial movement; and the pipeline 320 is connected to another hydraulic pump 322 where the fluid is further pressurized and then forced to flow into the fluid chamber 303 for causing the first movable pulley 302 to move. As the pressure in the fluid chamber 303 will gain from both the two hydraulic pumps 322, 332, it is larger than that in another fluid chamber 313 gaining only from the hydraulic pump 332. Thus, the rotation speed of the servo motor 321 in the first hydraulic drive circuit 32 will be larger than that of the servo motor 331 in the second hydraulic drive circuit 33 which will enable the hydraulic control apparatus to achieve its minimum reduction ratio.

Except for starting to move from standing stop and cruising in high speed, the controller 35 is able to issue control commands according to different moving status of an accelerating carrier for controlling the servo motors 321, 331 and the hydraulic control circuit 34 and thus optimizing the performance of the power source while obtaining an optimal power transmission efficiency. In addition, the transmission control can be adjusted for matching with the optimal working efficiency regions of different power sources.

To sum up, the present invention provides a hydraulic control apparatus for speed ratio change that is capable of achieving a speed ratio change in a continuous manner while maintaining a power source of the hydraulic control apparatus to function within its optimum efficiency region for achieving low energy consumption and low pollution during the operation of the power source.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydraulic control apparatus for speed ratio change, comprising:
a first pulley unit, connected to a power source so as to be driven thereby;
a second pulley unit, coupled to the first pulley unit by a transmission belt while being connected to a power output mechanism;
a first hydraulic drive circuit, connected to the first pulley unit;
a second hydraulic drive circuit, connected to the second pulley unit;
a hydraulic control circuit, fluidly connected to the first and the second hydraulic drive circuits in respective; and
a controller, electrically connected to the first hydraulic drive circuit, the second hydraulic drive circuit and the hydraulic control circuit;
wherein, the controller is enabled to issue a control signal for controlling the hydraulic control circuit to perform a task selected from the group consisting of: enabling the first hydraulic drive circuit and the second hydraulic drive circuit to serial-connected with each other, and enabling the first hydraulic drive circuit and the second hydraulic drive circuit to be parallel-connected with each other.

2. The apparatus of claim 1, wherein the hydraulic control circuit is further configured with a control valve and a plurality of pipelines in a manner that the control valve is fluidly connected to the first hydraulic drive circuit, the second hydraulic drive circuit and a fluid tank through the plural pipelines.

3. The apparatus of claim 2, wherein the control valve is a solenoid electric valve.

4. The apparatus of claim 3, wherein the solenoid electric valve is a 3-way 2-position solenoid valve.

5. The apparatus of claim 1, wherein the first hydraulic drive circuit further comprises:
a servo motor, connected to the controller by a motor control unit; and
a hydraulic pump, connected to the servo motor for receiving power from the same and thus outputting a controllable hydraulic pressure accordingly, and further connected to the first pulley unit and the hydraulic control circuit by way of two independent pipelines in respective.

6. The apparatus of claim 1, wherein the second hydraulic drive circuit further comprises:
a servo motor, connected to the controller by a motor control unit; and
a hydraulic pump, connected to the servo motor for receiving power from the same and thus outputting a controllable hydraulic pressure accordingly, and further connected to the second pulley unit and the hydraulic control circuit by way of two independent pipelines in respective.

7. The apparatus of claim 6, wherein the hydraulic pump is further connected to a fluid tank.

8. The apparatus of claim 1, wherein the transmission belt is a metal belt.

9. The apparatus of claim 1, capable of being adapted for mounting on a carrier.

10. The apparatus of claim 9, wherein the controller is enabled to issue the control signal according to the moving status of the carrier.

11. The apparatus of claim 1, wherein the first pulley unit is comprised of a first fixed pulley and a first movable pulley in a manner that the first movable pulley is slidably mounted on the first fixed pulley while forming a fluid chamber between the two; and the fluid chamber is used for holding a fluid therein and consequently causing a pressure to be exerted on the first movable pulley so as to force the same to perform an axial movement.

12. The apparatus of claim 1, wherein the second pulley unit is comprised of a second fixed pulley and a second movable pulley in a manner that the second movable pulley is slidably mounted on the second fixed pulley while forming a fluid chamber between the two; and the fluid chamber is used for holding a fluid therein and consequently causing a pressure to be exerted on the second movable pulley so as to force the same to perform an axial movement.
